(19) United States
(12) Patent Application Publication
(10) Pub. No.: US 2008/0212037 A1
(43) Pub. Date: Sep. 4, 2008

(54) MINIATURE COLOR DISPLAY APPARATUS

(75) Inventors: Ihar Shyshkin, Suwon-si (KR); Kwan-Young Oh, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/024,680

(22) Filed: Feb. 1, 2008

(30) Foreign Application Priority Data
Feb. 2, 2007 (KR) 10-2007-0011235

(51) Int. Cl. G03B 21/14

(52) U.S. Cl. 353/33; 353/31

(57) ABSTRACT

A miniature color display apparatus are disclosed. In accordance with an embodiment of the present invention, the miniature color display apparatus can include N light sources, emitting each two-dimensional color beam of light, N is a natural number and is the same as or larger than 3; a path adjusting material, adjusting an emission path of each color beam of light to allow each color beam of light emitted from the N light sources to be emitted though the same path; an optical modulator, optically modulating each incident color beam of light according to light intensity information; and a beam converter, converting the two-dimensional color beam of light to a one-dimensional color beam of light to allow each color beam of light having the emission path adjusted by the path adjusting material to be one-dimensionally incident on the optical modulator.

### CROSS-REFERENCE TO RELATED PATENT APPLICATIONS

This application claims the benefit of Korean Patent Application No. 10 2007-0011235, filed on Feb. 2, 2007, in the Korean Intellectual Property Office, the disclosure of which is incorporated herein in its entirety by reference.

### BACKGROUND OF THE INVENTION

1. Field of the Invention

The present invention relates to a color display apparatus, more specifically to a miniature color display apparatus using a projection method.

2. Background Art

Today's development of display technologies has brought about the increase of demands for small sized display apparatuses such as portable terminals, personal digital assistants (PDA) and portable multimedia players (PMP) as well as big sized display apparatuses such as TV and monitors. Particularly, projection type display apparatuses has been popular with users thanks to their price competitiveness and their appropriateness for realizing big images as compared with other big sized display apparatuses such as CRT TV, LCD TV and PDP TV.

However, since the conventional projection type apparatus has some difficulties in being applied to a small sized display apparatus due to a lot of quantities and complexity of elements (e.g. a light source, a mirror and an optical lens) used to realize an image and necessity to acquire a predetermined spaced distance or projection distance between elements. In other words, the conventional art is limited in ministration when realizing the projection type apparatus.

### SUMMARY OF THE INVENTION

Accordingly, the present invention provides a miniature projection type color display apparatus that is applicable to small sized apparatuses such as portable terminals, and PDA as well as big sized display apparatuses.

The present invention also provides a miniature projection type color display apparatus that can not only have simple configuration and low manufacturing cost but also miniaturize the display apparatus.

An aspect of present invention features miniature color display apparatus including N light sources, emitting each two-dimensional color beam of light, N is a natural number and is the same as or larger than 3; a path adjusting material, adjusting an emission path of each color beam of light to allow each color beam of light emitted from the N light sources to be emitted though the same path; an optical modulator, optically modulating each incident color beam of light according to light intensity information; a beam converter, converting the two-dimensional color beam of light to a one-dimensional color beam of light to allow each color beam of light having the emission path adjusted by the path adjusting material to be one-dimensionally incident on the optical modulator; and a scanner, receiving the modulated beam of light generated by the optical modulator and two-dimensionally projecting the received modulated beam of light on a screen.

Here, the miniature color display apparatus of the present invention can further include a collimation lens, adjusting an emission angle of the color beam of light emitted by the light source to allow the color beam of light emitted from the light source to be emitted in parallel.

The light source 110 can be one of a luminescent diode (LED), a laser diode (LD) and an organic light emitting diode (OLED). Also, the N light sources can be 3 light sources of a first light source, a second light source and a third light source, which emit each different color beam of light, and the path adjusting material can be arranged in front of each light source one by one per each light source. At this time, the first light source, the second light source and the third light source can be light sources of 3 primary colors of light, red, green and blue.

The path adjusting material is a totally reflective prism having a plurality of reflective surfaces. At this time, any one of the path adjusting materials arranged one by one per each light source can further include a first lens, coupled to an incident surface of the totally reflective prism and enlarging a diameter of the two-dimensional color beam of light emitted from the light source; and a second lens, coupled to an emission surface of the totally reflective prism and allowing the two-dimensional color beam of light emitted through the totally reflective prism to be incident on the beam converter in parallel.

The beam converter can include a one-dimensional beam formation lens, maintaining a length of a first axis direction of the two-dimensional color beam of light as it is and allowing a length of a second axis direction which is orthogonal to the first axis direction to be concentrated on a focusing point of the optical modulator.

Also, the one-dimensional beam formation lens can be a cylinder lens in which curvature is placed on any one directional surface, whereas the one directional surface on which the curvature is placed can be a surface corresponding to the same direction as the second axis direction of the two-dimensional color beam of light. The one directional surface of the cylinder lens can be an aspheric profile.

Here, the optical modulator can include a substrate; an insulation layer, placed on the substrate; a lower optical reflection layer, placed on the insulation layer and reflecting or diffracting an incident beam of light; a structure layer, having a center part which is placed away from the insulation layer at a predetermined interval; an upper optical reflective layer, placed on the center part of the structure layer and reflecting or diffracting the incident beam of light; and a piezoelectric driving element, placed on the structure layer and allowing the center part of the structure layer to move up and down.

The miniature color display apparatus of the present invention can further include an image control circuit, generating the light intensity information and transferring the generated light intensity information to the optical modulator.

The miniature color display apparatus of the present invention can further include a projection lens enlarging a projection range of the modulated beam of light that is two-dimensionally projected on the screen.

The scanner can be a polygon mirror scanner or a galvanometer scanner.

### BRIEF DESCRIPTION OF THE DRAWINGS

These and other features, aspects and advantages of the present invention will become better understood with regard to the following description, appended Claims and accompanying drawings where:

FIG. 1 illustrates an outline of a structure of a miniature projection type color display apparatus in accordance with an embodiment of the present invention;

FIG. 2A through FIG. 2C illustrate an example of each color illumination module in the miniature color display apparatus of FIG. 1;

FIG. 2D shows an example of actually realized data of a green illumination module;

FIG. 3A is an example of a graph showing the uniformity of color light incident on an optical modulator after passing through an illumination module in a miniature color display apparatus of the present invention;

FIG. 3B is an example of a graph showing the thickness of color light incident on an optical modulator after passing through an illumination module in a miniature color display apparatus of the present invention;

FIG. 3C is an example of a graph showing the type of color light incident on an optical modulator after passing through an illumination module in a miniature color display apparatus of the present invention;

FIG. 4A and FIG. 4B illustrate an example showing an optical modulator that is applicable to a miniature color display apparatus of the present invention;

FIG. 4C through FIG. 4E illustrate the optical modulating principle for the optical modulator of FIG. 4A or FIG. 4B;

FIG. 5A illustrates a projection module of a miniature color display apparatus of the present invention, and FIG. 5B shows an example of actually realized data of the projection module; and

FIG. 6A and FIG. 6B are examples of graphs showing the projection efficiency of modulated light when projected on a screen after passing through a projection module in a miniature color display apparatus.

### DESCRIPTION OF THE EMBODIMENTS

Hereinafter, a miniature color display apparatus in accordance with some embodiments of the present invention will be described in detail with reference to the accompanying drawings. Throughout the drawings, similar elements are given similar reference numerals, and corresponding overlapped description will be omitted. Throughout the description of the present invention, when describing a certain technology is determined to evade the point of the present invention, the pertinent detailed description will be omitted.

When one element is described as being “emitted” or “projected” to or on another element, it shall be construed as being emitted to or projected on the other element directly but also as possibly having another element in between. On the other hand, if one element is described as being “directly emitted” to or “directly projected” on another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

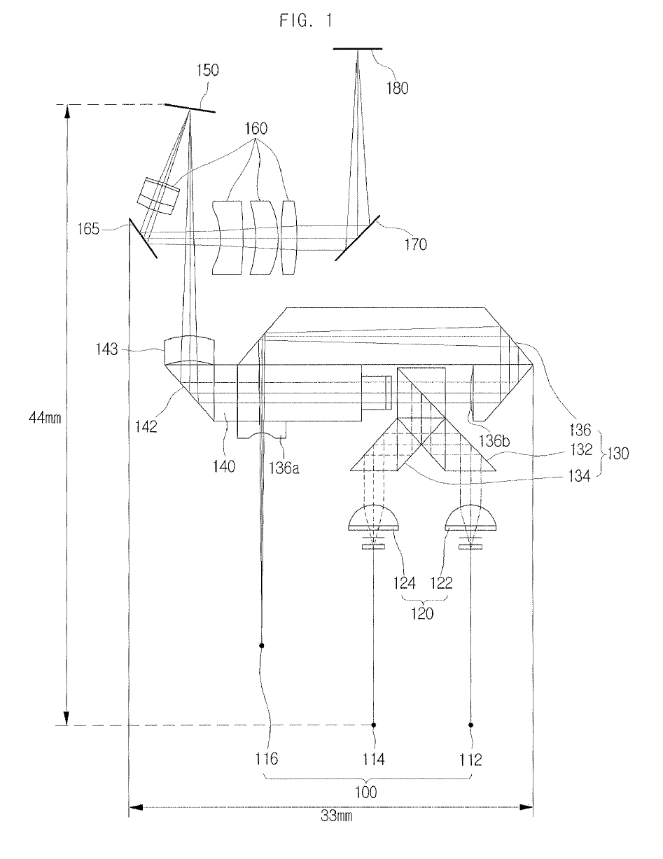

FIG. 1 illustrates an outline of a structure of a miniature projection type color display apparatus in accordance with an embodiment of the present invention. Particularly, FIG. 1 illustrates a miniature projection type color display apparatus in accordance with an embodiment of the present invention when viewed from an upper side.

Referring to FIG. 1, the miniature projection type color display apparatus in accordance with an embodiment of the present invention can include a light source 110, a collimation lens 120, a path adjusting material 130, a beam convertor 140, an optical modulator 150, a projection lens 160 and a scanner 170. Here, the light source 110, the collimation lens 120, the path adjusting material 130 and the beam converter 140 can be included in an illumination module in the miniature color display apparatus in accordance with an embodiment of the present invention. The projection lens 160 and the scanner 170 can be included in a projection module in the miniature color display apparatus in accordance with an embodiment of the present invention. For example, as shown in FIG. 1, the miniature color display apparatus of the present invention can have the size of 44 mm in a transverse direction and 33 mm in a vertical direction.

In accordance with the present invention, the light source 110 can consist of combination of light sources capable of emitting at least 3 color beams of light for realizing color image on a screen 180. Accordingly, the miniature color display apparatus in accordance with an embodiment of the present invention can include 3 light sources of a red light source 112, a blue light source 114 and a green light source 116 corresponding to 3 primary colors of light. The red light source 112, the blue light source 114 and the green source 116 can emit each two-dimensional beam.

Alternatively, it is natural that the light source 110 can consist of different combination of 3 color light sources or 4 or more color light sources from an embodiment of the present invention. The light source 110 can be realized by employing one of a luminescent diode (LED), a laser diode (LD) and an organic light emitting diode (OLED).

The collimation lens 120 can adjust an emission angle of color light emitted from the light source 110 in order to allow the color light emitted from the light source 110 to be emitted in parallel. In other words, while passing though the collimation lens 120, the color light emitted from the light source 110 can be diffused and collimated in parallel simultaneously. In the miniature color display apparatus in accordance with the embodiment of the present invention, as shown in FIG. 1, a collimation lens 122 and a second collimation lens 124 can be placed in front of the red light source 112 and the blue light source 114, respectively, and no additional collimation lens may be placed in front of the green light source 116.

Alternatively, it is natural that an additional collimation lens can be placed in front of the green light source 116. In case that the below-described path adjusting material 130 can simultaneously perform the parallel collimation function (refer to a third path adjusting material 136 placed in front of the green light source 116), it is obvious that no additional collimation lenses may be placed in front of the red light source 112 and the blue light source 114.

At this time, the numerical aperture (NA) of two-dimensional color beam of light emitted from each light source can be set as follows. For example, in case that each additional collimation lenses placed in front of the red source 112 and the blue source 114, the NA can be determined as 0.3. In case that no additional collimation lens placed in front of the green light source 116, the NA can be determined as 0.005. The NA can be typically be defined as n×sin θ. Here, n indicates the refractive index of a medium in a path through which the color light emitted from the light source 110 moves, and θ indicates the maximum emission angle of color light based on an optical axis of the color light emitted from the light source 110.

Accordingly, if it is assumed that the path through which the color light moves is the air having the refractive index of 1, in the case of the red light source 112 and the blue light source 114, each maximum emission angle can be determined as approximately 17.46°(=sin⁻¹ 0.3) to emit red light and blue light. In the case of the green light source 116, the maximum emission angle can be determined as approximately 0.29° (=sin⁻¹ 0.005) to emit green light. As such, the reason that the color light is emitted by differentiating the NA of color light per each light source is to allow each color light emitted from per light source to pass through the collimation lens 120 and the path adjusting material 130 in accordance with the present invention and then to have the same diameter and to simultaneously be incident on the below-described beam convertor 140. Accordingly, it is obvious that the NA of color light per light source can be determined as different values from the forgoing examples.

As such, the red light emitted from the red light source 112 and the blue light emitted from the blue light source 114 can pass through the first collimation lens 122 and the second collimation 124, respectively, to be incident on the path adjusting material 130 (more exactly, a first path adjusting material 132 and a second path adjusting material 134, respectively, in the case of the embodiment of the present invention). The green light emitted from the green source 116 can be directly incident on the path adjusting material 130 (more exactly, a third path adjusting material 136 in the case of the embodiment of the present invention).

The path adjusting material 130 can adjust an emission path of each color light in order to allow each incident color light to be emitted through the same path. In other words, the path adjusting material 130 can allow each incident color light to be emitted through the same path, to thereby to be incident on the single beam convertor in the miniature color display apparatus of the present invention. As such, the reason that the path adjusting material 130 is placed in the miniature color display apparatus of the present invention is because it is necessary to allow each color light all to move through the same (single) path that passes through the beam convertor 140 and leads to the optical modulator 150 in order to be optically modulated by the optical modulator 150 of 1 panel.

If it is assumed that no path adjusting material 130 is placed, each path lead to the optical modulator 150 of the 1 panel per color light becomes different. This results in the increase of the volume of the optical system, to thereby be limited to realize the small (or miniature) color display apparatus. To recover the limitation, the optical modulator of 3 panels can be equipped. This case may be brought about that the optical system has a complex structure and the color display apparatus has the increased manufacturing cost.

Accordingly, the present invention can allow the optical system to have a complex structure and the manufacturing cost to be reduced and manufacture a smaller-sized color display apparatus by equipping the path adjusting material 130 (e.g. a totally reflective prism simply having a plurality of reflective surfaces.

For example, in the miniature color display apparatus in accordance with an embodiment of the present invention, as shown in FIG. 1, each one path adjusting material per light source, a total of 3 path adjusting materials 130 (i.e. the first path adjusting material 132, the second path adjusting material 134 and the third path adjusting material 136), can be placed in front of each light source. Alternatively, at least two (or all) of the 3 path adjusting materials can be realized in a form of one unified path adjusting material 130.

The beam convertor 140 can receive each color light, the emission path of which is adjusted by the path adjusting material 130, and converts each 2-dimensional color beam of light to each 1-dimensional color beam of light in order to allow the 1-dimensional color beam of light to be incident on optical modulator 150.

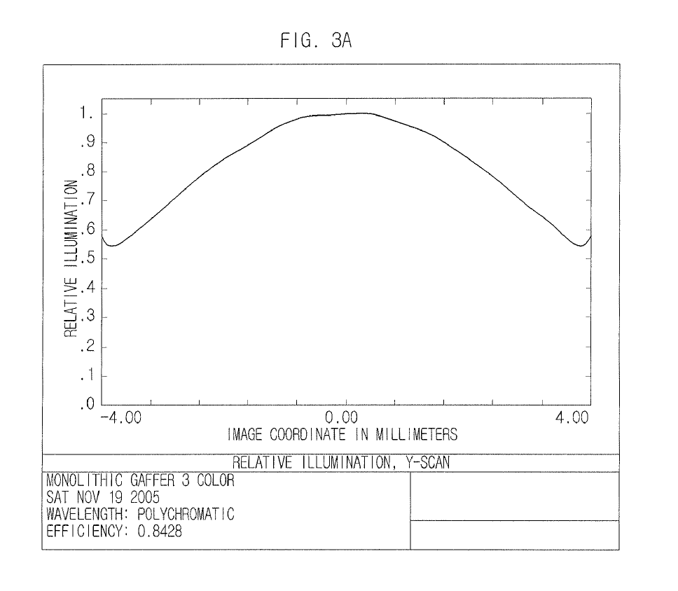

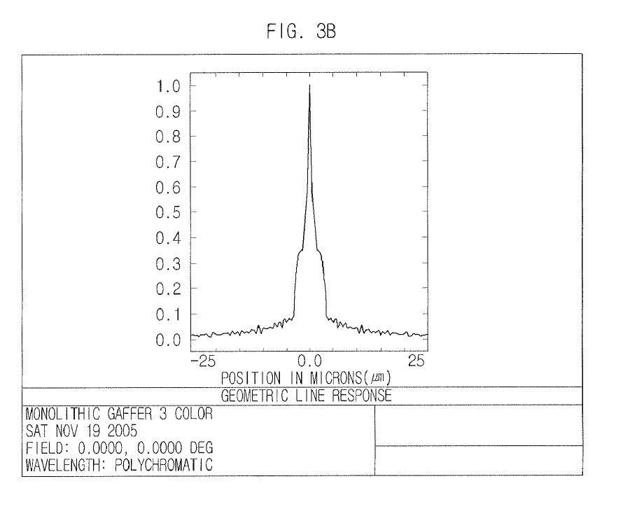

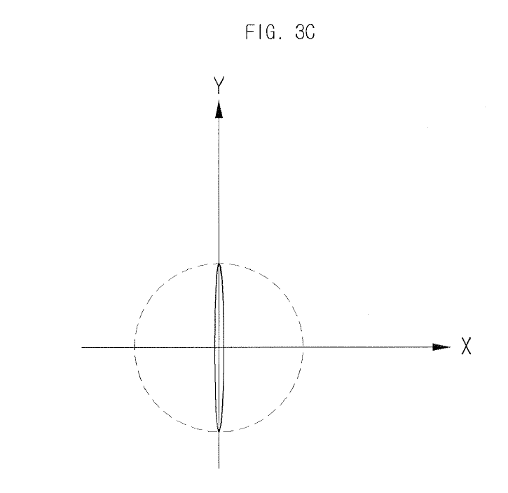

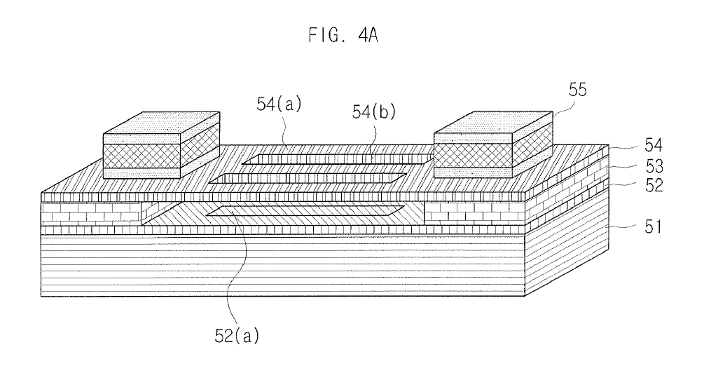

As such, the beam convertor 140 can include a 1-dimensional beam formation lens 143 for converting 2-dimensional color beam of light to 1-dimensional color beam of light. For example, the 1-dimensional beam formation lens 143 can convert 2-dimensional color beam of light to 1-dimensional beam of color beam of light by allowing the length of a first axis direction (e.g. a y-axis direction) of the incident 2-dimensional color beam of light to be maintained as it is and the length of a second axis direction (is orthogonal to the first axis direction and for example, x-axis direction) of the 2-dimensional color beam of light to be concentrated on an focusing point of the optical modulator (refer to FIG. 3C to be described below).

As an example of the 1-dimensional beam formation lens 143, a cylinder lens in which curvature is placed on any one directional surface only can be used. At this time, any one directional surface on which the curvature is placed can be the surface corresponding to the same direction as the second axis direction to be concentrated on a focusing point of the optical modulator among the 2-dimensional color beam of light. Alternatively, any one directional surface on which the curvature is placed can be formed as an aspheric profile in order to remove spherical aberration at a maximum.

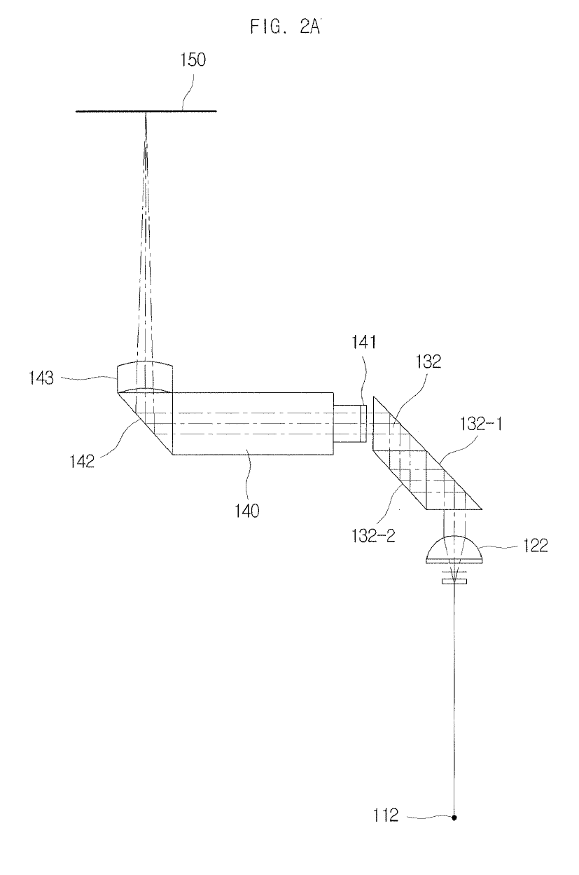

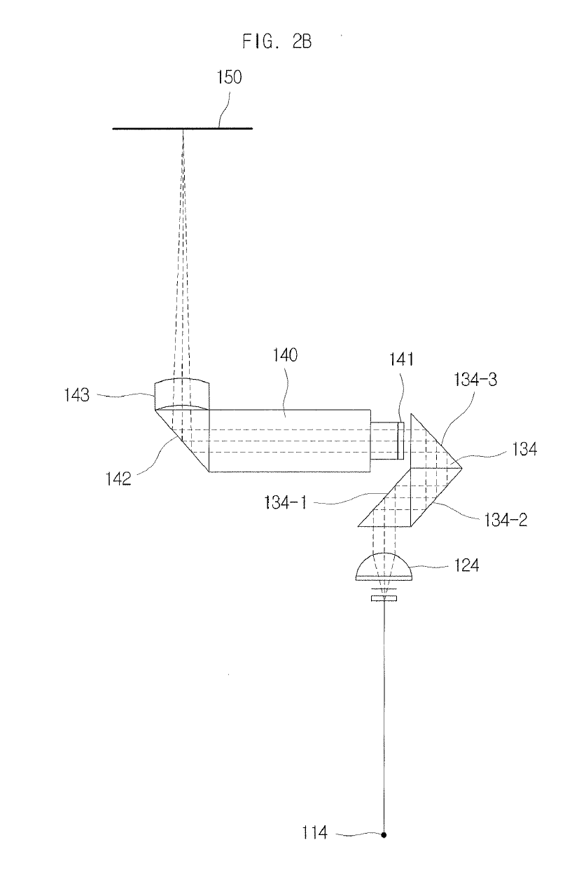

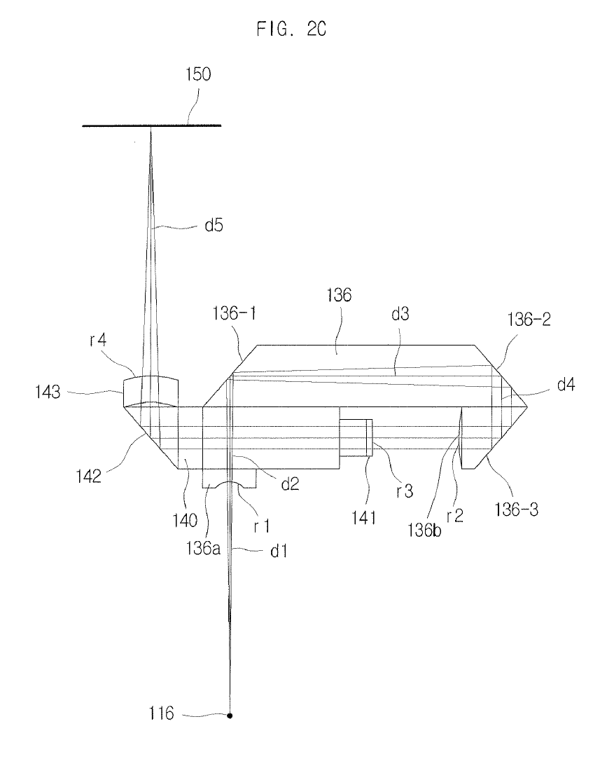

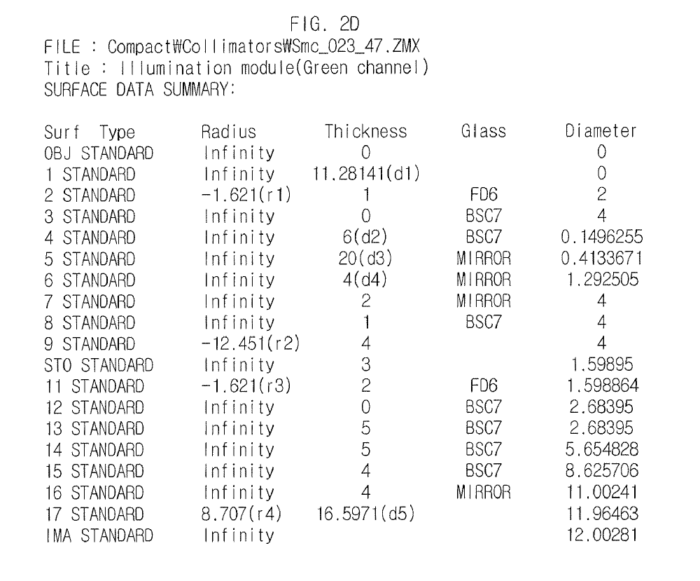

The illumination module including the path adjusting material 130 and the beam converter 140 in accordance with the present invention will be described in detail with reference to FIG. 2A through FIG. 2E.

The optical modulator 150 can generate modulated (diffracted) light to which each incident color light is optically modulated corresponding to predetermined light intensity information (or image information). Here, the predetermined light intensity information can refer to image information per each color light related to an actual color image to be realized on the screen 180. The light intensity information can be generated by an additional image control circuit (not shown) before transferred to the optical modulator 150. In other words, the optical modulator 150 can generate modulated light on which the image information is loaded by receiving a 1-dimensional color beam of light without image information and performing the optical modulation of the received color beam of light corresponding to the predetermined light intensity information transferred from the image control circuit (not shown).

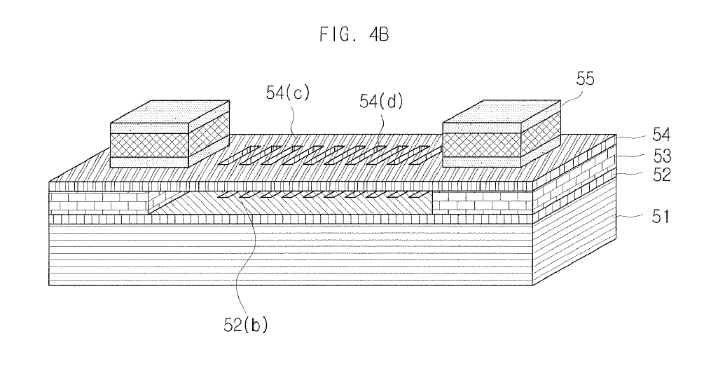

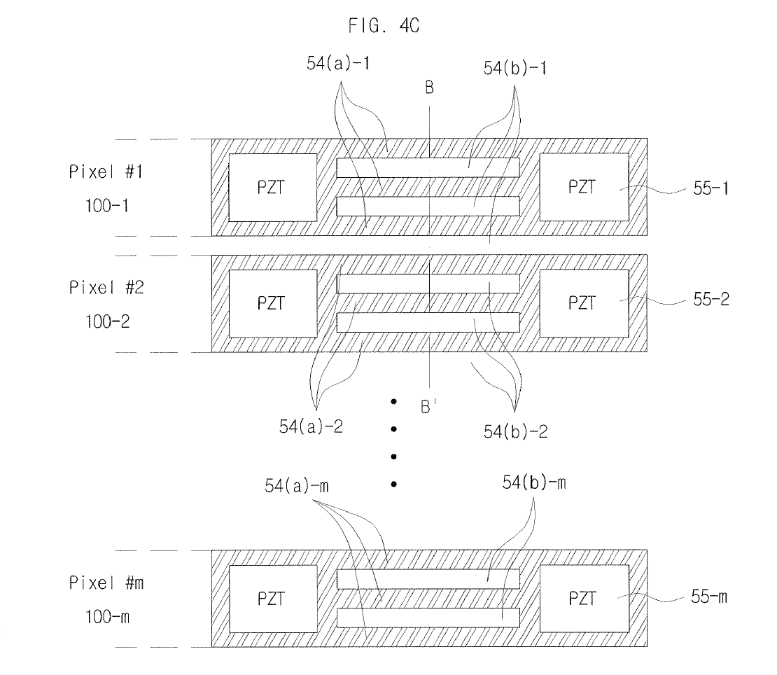

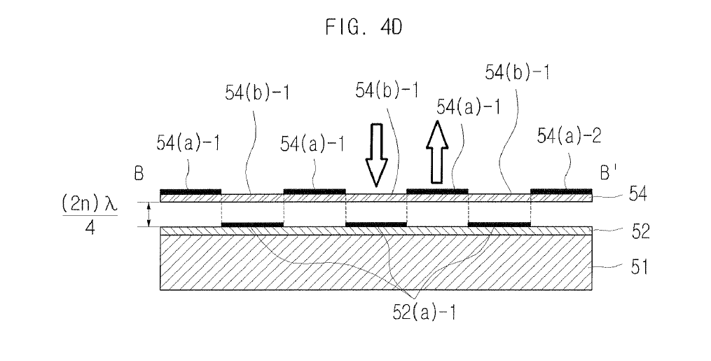

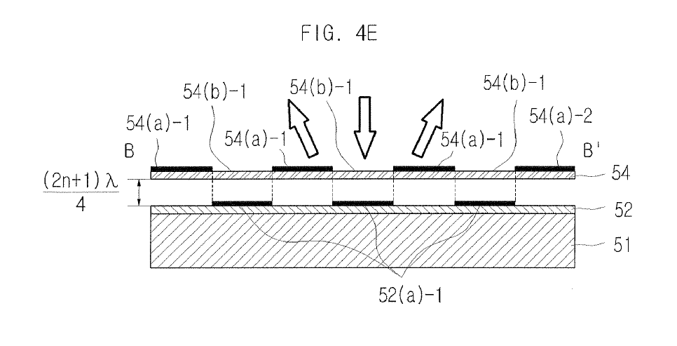

An example of the optical modulator 150 applicable to the present invention and the optical modulation principle of color light using the optical modulator 150 will be described in detail with reference to FIG. 4A through FIG. 4E. As such, the modulated light optically modulated by the optical modulator 150 can be transferred to (incident on) the projection module (e.g. the projection lens and the scanner 170) of the present invention.

The scanner 170 can receive the modulated light generated by the optical modulator 150 and project the received light on the screen 180 two-dimensionally. The scanner 170 can employ a polygon mirror scanner or a galvanometer scanner of the embodiment of the present invention. Alternatively, it is natural that any device capable of two-dimensionally scanning incident color light on the screen 180 (for the reference, FIG. 1 shows a part of the circle shape of the screen 180 for the convenience of illustration and the same shall apply hereinafter) according to single directional or two directional rotation can be used without restriction.

The projection lens 160 can enlarge a projection range of the modulated light two-dimensionally projected on the screen 180. Although the projection lens 160 may be unnecessary for the miniature color display apparatus of the present invention, equipping the projection lens 160 can reduce the volume (or size) of the color display apparatus.

For example, it is assumed that the modulated generated by the optical modulator 150 is directly incident on the scanner 170 without passing through the projection lens 160, since the diameter of the modulated light incident on the scanner 170 is not enough in size, it may be necessary to control the scanner 170 to make more rotations (or to have a quicker rotation speed) or to acquire a longer spaced distance between the scanner 170 and the screen 180.

Accordingly, enlarging the projection range of the modulated light to be two-dimensionally projected on the screen 180 in advance by using the projection lens 160 can solve the above problem and miniaturize the color display apparatus. However, it is not necessary to equip the projection lens 160 between the optical modulator 150 and scanner 170 like the embodiment of the present invention. The projection lens 160 can be alternatively placed between the scanner 170 and the screen 180.

Also, the projection lens 160 can be realized as a plurality of lens arrays like the embodiment of the present invention, but alternatively, the projection lens 160 can be realized as one unified module. In the embodiment of the present invention, not only the projection lens 160 but also a reflective mirror 165 can be placed to maximize the space usability of the display apparatus for the miniaturization of the color display apparatus. It is obvious that the reflective mirror 165 is not included in the necessary elements of the present invention.

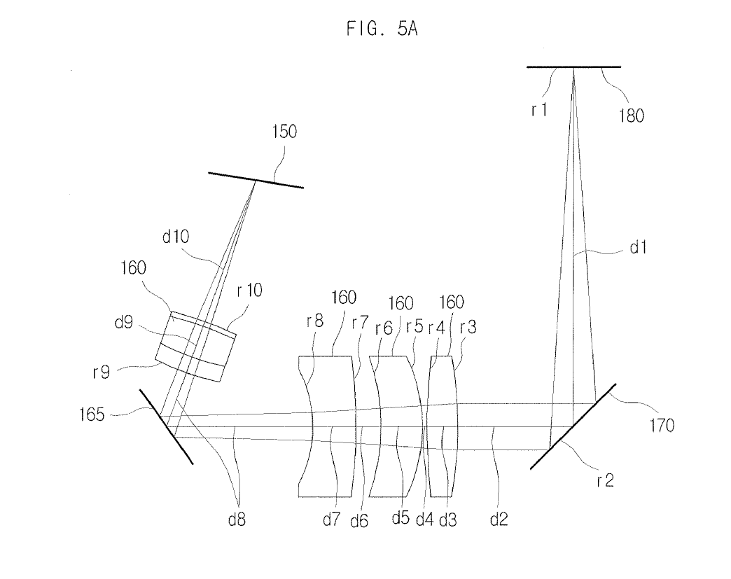

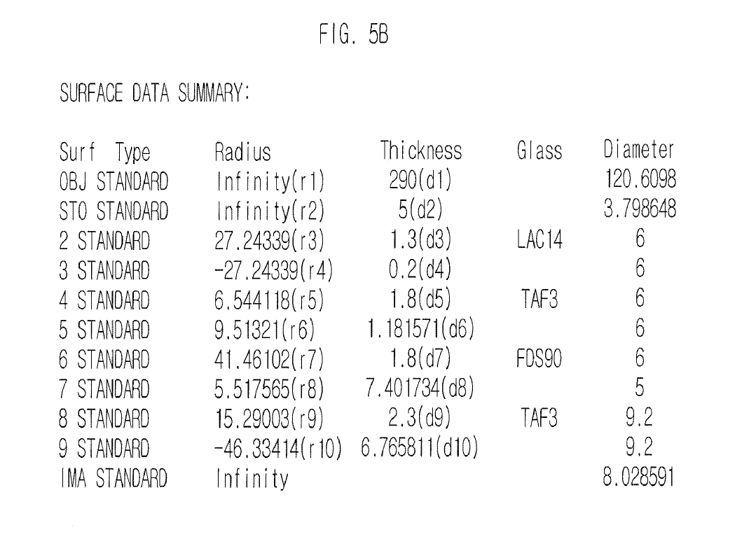

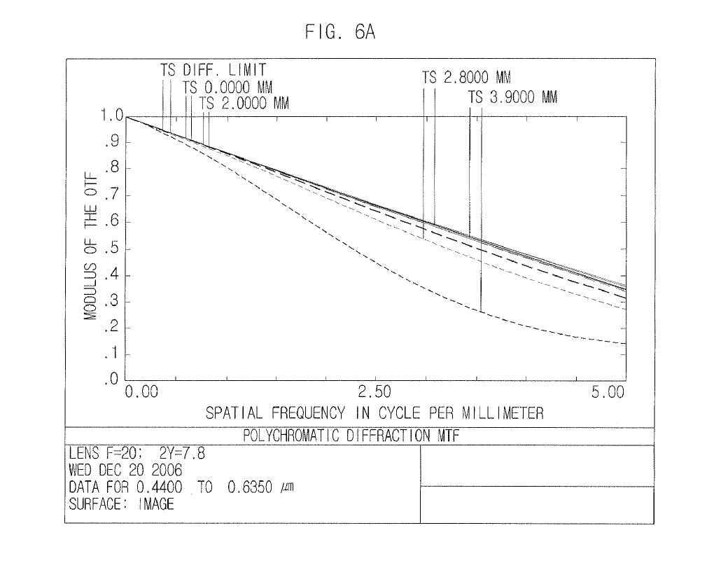

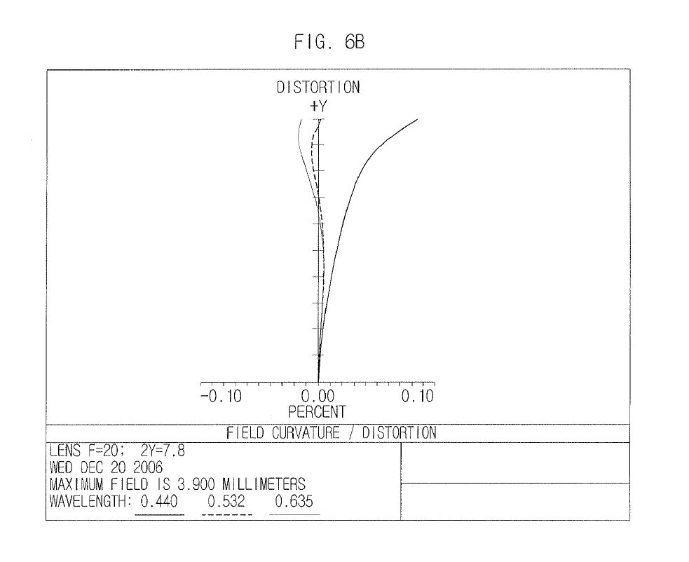

The projection module including the projection lens 160 and the scanner 170 in accordance with the present invention will be described below in detail with reference to FIG. 5A through FIG. 6C.

FIG. 2A through FIG. 2C illustrate an example of each color illumination module in the miniature color display apparatus of FIG. 1. In particularly, FIG. 2A shows the path through which red light emitted from the red light source 112 passes through the illumination module of the present invention and leads to the optical modulator 150 of the 1 panel, and FIG. 2B shows the path through which blue light emitted from the blue light source 114 passes through the illumination module of the present invention and leads to the optical modulator 150 of the 1 panel. FIG. 2C shows the path through which green light emitted from the green light source 116 passes through the illumination module of the present invention and leads to the optical modulator 150 of the 1 panel.

Referring to FIG. 2A, the red light 112 emitted from the red light source 112 can pass through the first collimation lens 122 and be diffracted and collimated in parallel before being incident on the first path adjusting material 132, and the red light incident on the first path adjusting material 132 can be successively reflected by a first reflective surface 132-1, a second reflective surface 132-2 and the first reflective surface 132-1 before being incident on an incident surface 141 of the beam converter 140. The red beam incident on the incident surface 141 can be reflected by a reflective surface 142 of the beam converter 140 and pass through the 1-dimensional beam formation lens 143 to convert the 2-dimensional red beam of light to a 1-dimensional red beam of light before being incident on the optical modulator 150 1-dimensionally.

Since the principle that blue light emitted from the blue light source 114 passes through the illumination module (e.g. the second collimation lens 124, the second path adjusting material 134 and the beam converter 140) and leads to the optical modulator 150 as shown in FIG. 2B is the same as that of FIG. 2A, the pertinent detailed description

Referring to FIG. 2C, green light emitted from the green light source 116 can be directly incident on the third path adjusting material 136 without passing through an additional collimation lens. At this time, the incident green light can be diffracted and collimated in parallel by a first lens 136a, a first reflective surface 136-1, a second reflective surface 136-2, a third reflective surface 136-3 and a second lens 136b of the third path adjusting material 136 before being incident on the incident surface 141 of the beam converter 140.

Particularly, the diameter of the two-dimensional green beam of light emitted from the green light source 116 can be enlarged by the first lens 136a of the third path adjusting material 136, and the green beam of light having the enlarged diameter can be successively reflected by the first reflective surface 136-1, the second reflective surface 136-2 and the third reflective surface 136-3 before being incident on the second lens 136b. At this time, the emission angle of the green beam of light incident on the second lens 136b can be adjusted in order to allow the green beam to incident in parallel on the beam converter 140 while the green beam is passing through the second lens 136b.

Here, the first lens 136a can employ a concave lens so as to enlarge the diameter of the incident two-dimensional color beam of light and/or a convex lens allowing the emission angle of the two-dimensional color beam of light having the enlarged diameter to be reduced and the color beam of light to be incident in parallel on the beam converter 140. In other words, it is recognized that the third path adjusting material 136 can function as the collimation lens diffracting and collimating the green beam of light in parallel through the first lens 136a and the second lens 136b equipped in the third path adjusting material 136 in addition to as adjusting the emission path of the green beam of light.

At this time, as described above, the third path adjusting material 136 can be realized in a form in which the first lens 136a and the second lens 136b is further coupled and unified to a totally reflective prism used as the first path adjusting material 132 or the second path adjusting material 134, in order to make it possible to adjust, diffuse and collimate in parallel the emission path of the green beam of light.

For example, as described in FIG. 2C, the diameter of the green beam of light can be enlarged by allowing the first lens 136a to be unified and coupled to an incident surface of the totally reflective prism, and the green beam of light emitted through the totally reflective prim (i.e. an optical member including the first reflective surface 136-1, the second reflective surface 136-2 and the third reflective 136-3) can be incident in parallel on the beam converter 140 by allowing the second lens 136b to be unified and coupled to an emission surface of the totally reflective prism. As such, the green beam of light incident on the beam converter 140 after passing through the third path adjusting material 136 can pass through the reflective surface 142 and the 1-dimensional beam formation lens 143 of the beam converter 140 to be 1-dimensionally incident on the optical modulator 150 by the same principle as shown in FIG. 2A.

In other words, the third path adjusting material 136 of the present invention can perform the two foresaid functions simultaneously by allowing the optical member (e.g. the totally reflective prism) for changing (or adjusting) an optical path of the color light to be unified and coupled to the optical member (e.g. the concave lens or the convex lens) for enlarging or reducing the emission angle of the color light. Accordingly, the present invention can improve space usability of the display apparatus better and minimize the size or the volume to manufacture the miniature color display apparatus as compared with the case of separately placing (or arranging) the optical member for light path adjustment and the optical member for enlarging or reducing the emission angle.

Also, as described with reference to FIG. 1, in the case of emitting each light by setting the NA of the red light source 112 and the blue light source 114 as 0.3 and the NA of the green light source 116 as 0.005, the emission angle of the green beam of light firstly emitted from the green light source 116 can become smaller than that of the color beams of light emitted from the other light sources. At this time, the green beam of light having the small emission angle of the firstly emitted color beam of light can need the longer light path than the other color beam of light in order to allow each color beam of light emitted per light source to have the same diameter (or size) and to be incident on beam converter 140.

However, the present invention can manufacture (or realize) the miniature color display apparatus by allowing the minimized space to be used by use of the optical member having the same form as the third path adjusting material 136 and two-dimensional beam of light having the same diameter as the other color beam of light to be made.

FIG. 2D shows an example of actually realized data of a green illumination module. Firstly, each parameter of the table of FIG. 2D will be described as follows. The ‘radius’ refers to the data indicating the curvature radius of each part in the illustration module of the present invention. The ‘thickness’ refers to the data the data indicating the distance of each part in the illustration module of the present invention. The ‘glass’ refers to the data indicating the glass properties of each part in the illustration module of the present invention. The ‘diameter’ refers to the data indicating the external diameter (or diameter) of the color beam of light diffused through each part in the illustration module of the present invention.

Here, if the curvature radius (i.e. the ‘radius’ of the table) has the value of infinity (i.e. the curvature radius is infinity), the pertinent part can be flat without the curvature. For example, it can be recognized that the 1-dimensional beam formation lens 143 of FIG. 2C has the curvature radius of (+) 8.707 (refer to r4 in the table).

Each distance between main parts of the illumination module of the green beam of light of the present invention will be described with the table of FIG. 2D. For example, in the illumination module of the present invention, the distance d1 between the green light source 116 and the incident surface of the third path adjusting material 136 can be 11.28141 mm. The distance d2 between the first reflective surface 136-1 and the incident surface of the third path adjusting material 136 can be 6 mm. The distance d3 between the first reflective surface 136-1 and the reflective surface 136-2 can be 20 mm. The distance d4 between the second reflective surface 136-2 and the third reflective surface 136-3 can be 4 mm. In addition, the distance d5 between the optical modulator 150 and the 1-dimensional beam formation lens 143 of the beam converter 140 can be 16.5971 mm.

As described above, the present invention can manufacture the miniature color display apparatus having the size of tens millimeters by using the illustration module including the path adjusting material 130 and the beam converter 140. However, the table of FIG. 2D is merely an example of actually realized data of the illustration module of the present invention. It is obvious that there can be alternatively various examples having different values from the table of FIG. 2D.

FIG. 3A is an example of a graph showing the uniformity of color light incident on an optical modulator after passing through an illumination module in a miniature color display apparatus of the present invention. Here, the x-axis of the graph indicates the distance based on the center of a first axis direction of the optical modulator 150 (i.e. a first axis direction of the color light incident on the optical modulator 150), and the y-axis of the graph indicates the relative illumination.

Referring to FIG. 3A, if the illumination of the center of the first axis direction is assumed to be 1, it can be recognized that the more distant area from the center has smaller relative illumination. However, the relative illumination of the area between the center and approximately ±4 mm is maintained as the value of about 0.5. In case that the color light incident on the optical modulator 150 has the relative illumination of 0.5 or higher, the color light can be generally considered as having the high uniformity.

This can means that in the case of manufacturing the optical modulator 150 to have the length of approximately ±4 mm from the center in the first axis direction, the color light incident in the first axis direction of the optical modulator 150 can be maintained to have uniform brightness (or intensity). As such, maintaining uniformly the brightness (or magnitude) of the color light incident on the optical modulator 150 can perform more accurate optical modulation through the optical modulator 150, to thereby improve the accuracy of the color image realization in the miniature color display apparatus of the present invention.

FIG. 3B is an example of a graph showing the thickness of color light incident on an optical modulator after passing through an illumination module in a miniature color display apparatus of the present invention. Here, the x-axis of the graph indicates the distance based on the center of a second axis direction of the optical modulator 150 (i.e. a second axis direction of the color light incident on the optical modulator 150), and the y-axis of the graph indicates the relative illumination.

Referring to FIG. 3B, it can be recognized that the illumination of the color light that is incident after passing through the illumination module of the present invention is nearly concentrated on the center of the second axis direction of the optical modulator 150 and merely has the width of 20 μm (based on the illumination of 13.5% as compared with the maximum illumination at the center). As a result, this can means that the 2-dimensional color beam of light is converted to a 1-dimensional color beam of light by passing through the beam converter 140 of the present invention before being incident on the optical modulator 150.

FIG. 3C is an example of a graph showing the type of color light incident on an optical modulator after passing through an illumination module in a miniature color display apparatus of the present invention. Here, the dotted line of FIG. 3C shows an example of the two-dimensional color beam of light before passing through the 1-dimensional beam formation lens 143 of the beam converter 140 of the present invention. At this time, the 2-dimensional color beam is assumed to have a circle shape. Also, the line of FIG. 3C shows an example of the 1-dimensional color beam of light incident on the optical modulator 150 after passing through the 1-dimensional beam formation lens 143 of the present invention.

In other words, as described with reference to FIG. 3C, while being passing through the 1-dimensional beam formation lens 143, the two-dimensional color beam of light can be converted to the 1-dimensional color beam of light by allowing the length of a first axis direction (e.g. the y-axis direction of the embodiment of the present invention) to be maintained as it is and the length of a second axis direction (e.g. the x-axis direction of the embodiment of the present invention) to be concentrated on a focusing point of the optical modulator 150. Here, the focusing point of the optical modulator 150 refers to a point having a smaller area than the size of 1 pixel (e.g. tens of micrometers of each length in transverse and vertical directions) in the optical modulator 150. Accordingly, the 1-dimensional color beam of light defined in the specification can be the color beam of light incident on the optical modulator 150, the width (or length) of any one axis direction (e.g. the second axis) of which has the size of the same as or smaller than 1 pixel. For example, the width (or length) of the second axis of the color beam of light can be 20 μm as described with reference to FIG. 3B.

FIG. 4A and FIG. 4B illustrate an example showing an optical modulator that is applicable to a miniature color display apparatus of the present invention. FIG. 4A is a perspective view illustrating a type of a piezoelectric optical modulator applicable to the present invention, and FIG. 4B is a perspective view illustrating another type of a piezoelectric optical modulator applicable to the present invention.

Here, the optical modulator is mainly divided into a direct type, which directly controls the on/off state of light, and an indirect type, which uses reflection and diffraction. The indirect type can be further divided into an electrostatic type (e.g. grating light value (GLV) device of the Silicon Light Machines) and a piezoelectric type. The optical modulator is applicable to the present invention regardless of the operation type. The optical modulation principle will be hereinafter described by mainly referring to the optical modulator shown in FIG. 4A and FIG. 4B.

Referring to FIG. 4A and FIG. 4B, the piezoelectric optical modulator applicable to an embodiment of the present invention, includes a substrate 51, an insulation layer 52, a sacrificial layer 53, a structure layer 54 and a piezoelectric driving element 55. Here, the sacrificial layer 53 can be placed at opposite end parts of the insulation layer 52 to allow the insulation layer 52 and the structure layer 54 to be away from each other at a predetermined interval. Of course, if the substrate 51 is realized in a form of having a depression, the sacrificial layer 53 can be omitted. The piezoelectric driving element 55 can supply a driving force allowing the structure layer 840 to move up and down according to a level of upward and downward or leftward and rightward contraction or expansion generated by the difference in voltage between upper and lower electrodes.

Here, a plurality of holes 54(b) or 54(d) can be placed in a center area of the structure layer 54. An upper optical reflection layer 54(a) or 54(c) reflecting or diffracting an incident beam of light can be formed in a center part of the structure layer 54 in which no hole is formed, and an lower optical reflection layer 52(a) or 52(b) reflecting or diffracting an incident beam of light can be formed at a point of the insulation layer 52 corresponding to the position of the hole. Hereinafter, the principle of optical modulation caused by the change of height between the structure layer 54 and the insulation layer 52 will be described with FIG. 4C through FIG. 4E.

FIG. 4C through FIG. 4E illustrate the optical modulating principle for the optical modulator of FIG. 4A or FIG. 4B. FIG. 4C is a plan view illustrating an optical modulator array consisting of the optical modulators of FIG. 4A, and FIG. 4D and FIG. 4E are sectional views of FIG. 4A, viewed along the line BB′.

Referring to FIG. 4C, the optical modulator array can be configured to include m micro-mirrors 50-1, 50-2, . . . , and 50-m, each of which corresponds to a first pixel (pixel #1), a second pixel (pixel #2), . . . and an m^{th} pixel (pixel #m), respectively. The optical modulator can deal with image information related to one-dimensional images of vertical or horizontal scanning lines (which are assumed to consist of m pixels), while each of the micro-mirrors 50-1, 50-2, . . . , and 50-m can deal with one pixel among the m pixels constituting the vertical or horizontal scanning line.

Accordingly, the beam of light reflected and/or diffracted by each micro-mirror can be projected as a two-dimensional image on a screen by a scanner. For example, in the case of a VGA resolution of 640*480, the modulation is performed 640 times for 480 vertical pixels in one surface of the scanner, to thereby generate one frame of display having a resolution of 640*480.

While the following description of the principle of optical modulation is based on the first pixel (pixel #1), the same description can be obviously applied to other pixels.

In this embodiment, it is assumed that 2 holes 54(b)-1 are formed in the structure layer 54. Due to the two holes 54(b)-1, 3 upper optical reflection layers 54(a)-1 can be formed in an upper part of the structure layer 54. The insulation layer 52 can be formed with 2 lower optical reflection layers 52(a)-1 corresponding to the two holes 54(b)-1. Also, another lower optical reflection layer 52(a)-1 can be formed in the insulation layer 52 corresponding to the distance between a first pixel (pixel #1) and a second pixel (pixel #2). Accordingly, for each pixel, the number of the upper reflection layers 54(a)-1 can be identical to that of the lower reflection layers 52(a)-1. This can make it possible to adjust the luminance of the modulated light using the 0^{th}-order diffracted light or ±1^{st}-order diffracted light.

Referring to FIG. 4D, in case that the wavelength of a beam of light is λ, a first power, which allows the gap between the structure layer 54 formed with the upper optical reflection layer 54(a) and the insulation layer 52 formed with the lower optical reflection layer 52(a) to be equal to (2n)λ/4, n being a natural number, can be supplied to the piezoelectric driving element 55. At this time, in the case of a 0^{th}-order diffracted (reflected) beam of light, the overall path length difference between the light reflected by the upper optical reflection layer 54(a) and the light reflected by the lower optical reflection layer 52(b) can be equal to nλ so that constructive interference occurs and the diffracted light can render its maximum luminance. Here, in the case of a +1^{st} or −1^{st} order diffracted light, the luminance of the light can be at its minimum value due to destructive interference.

Referring to FIG. 4E, a second power, which allows the gap between the structure layer 54 formed with the upper optical reflection layer 54(a) and the insulation layer 52 formed with the lower optical reflection layer 52(a) to be equal to (2n+1)λ/4, n being a natural number, can be supplied to the piezoelectric driving element 55. At this time, in the case of a 0th-order diffracted (reflected) beam of light, the overall path length difference between the light reflected by the upper optical reflection layer 54(a) and the light reflected by the lower optical reflection layer 52(a) can be equal to (2n+1)λ/2 so that destructive interference occurs, and the diffracted light can render its minimum luminance. Here, in the case of the +1^{st} or −1^{st} order diffracted light, the luminance of the light can be at its maximum value due to constructive interference. As the result of the foresaid interference, the optical modulator can load image information on the beam of light by adjusting the amount of reflected or diffracted light. The optical modulation of incident light can be performed by using the principle.

Although the foregoing describes the cases that the gap between the structure layer 54 and the insulation layer 52 is (2n)λ/4 or (2n+1)λ/4, it is obvious that a variety of embodiments, which are able to operate with a gap adjusting the intensity of interference by diffraction and reflection of the incident light, can be applied to the present invention.

FIG. 5A illustrates a projection module of a miniature color display apparatus of the present invention, and FIG. 5B shows an example of actually realized data of the projection module. Since the description related to each parameter in the table of FIG. 5B is the same as that of FIG. 2D, the pertinent description will be omitted. With reference to the projection module shown in FIG. 5A based on the table of FIG. 5B, the projection module in accordance with an embodiment of the present invention can be placed between the screen 180 (refer to the ‘OBJ STANDARD’ of FIG. 5B) and the optical modulator 150 (refer to the ‘IMA STANDARD) of FIG. 5B) and be partitioned into a total of sections.

For example, the distance d1 between the screen 180 and the scanner 170 can be 290 mm, and the distance between each other part can be d2 through d10. Also, the curvature radius can be the same as r1 through r10. It is obvious that the projection module of the present invention can have different values from the table of FIG. 5B as various examples.

FIG. 6A and FIG. 6B are examples of graphs showing the projection efficiency of modulated light when projected on a screen after passing through a projection module in a miniature color display apparatus.

FIG. 6A is graphs of modulation transfer function (MTF) showing the efficiency of the projection lens of the present invention. Here, the x-axis of FIG. 6A indicates a spatial frequency, and the y-axis indicates contrast. The spatial frequency can have the unit of lp/mm (line pair/mm), which indicates the quantity of a pair of lines (consisting of a white line and a black line). For example, in case of the screen has each distance of 200 μm within 1 mm and 5 pairs of lines (each of which one white line and one black line), the spatial frequency can be 5 lp/mm.

In the MTF graph, the increased spatial frequency can brought about the decrease of the contrast. It can be because increasing the quantity of the pairs of lines makes it more difficult to clearly distinguish the lines within 1 mm through human eyes. In other words, the MTF graph indicates the level capable of recognizing (or distinguishing) an image projected on the screen 180 through the human eyes.

Accordingly, referring to FIG. 6A, if it assumed that the contrast capable of generally recognizing the image of the screen 180 by a human is 0.3 (based on the case that the maximum contrast is 1), it can be recognized that the modulated light (or image) projected on the screen 180 after passing through the projection lens 160 of the present invention has the spatial frequency of approximately 5 lp/mm.

As a result, this can mean that if it is assumed that the projection lens 160 has the 20 magnifications, the spatial frequency in the optical modulator 150 having the contrast of approximately 0.3 is 100 lp/mm (=5 lp/mm×20). This can show that the projection lens 160 of the present invention has outstanding projection efficiency. Here, the 20 magnifications of the projection lens 160 can indicate that if the incident planar surface of the optical modulator 150 has the size of ±4 mm from the center, when the modulator light is projected on the screen 180, the projection planar surface has 20-times-enlarged size of ±80 mm.

FIG. 6B is graphs showing the distortion aberration when the modulated light passes through the projection lens 160 and is projected on the screen 180. The distortion aberration can be generated by the change (difference) of the magnifications per position of the lens. While the ideal lens can have constant magnifications (i.e. constant curvatures) per position in an external direction, the actual lens can have the magnifications per position that can be changed a little due to various factors such as process errors and incident directions (or angles) of the modulated light.

In other words, in the case that the modulated light passes through the projection lens 160 and is projected on the screen 180, as shown in FIG. 6B, the distortion aberration can be also generated by the difference in the magnifications of the projection lens per position. At this time, the positive value of the distortion aberration can allow each side to be seen as if the side is concave, and the negative value of the distortion aberration can allow each side to be seen as if the side is convex.

At this time, the distortion aberration of approximately ±2% or more can be recognized through the human eyes. As shown in FIG. 6B, since the projection lens 160 of the present invention has the distortion aberration of approximately ±1%, it can be recognized that the projection lens 160 of the present invention has the distortion aberration which is unable to be recognized through the human eyes. This can mean that the projection lens 160 has outstanding projection efficiency.

As described above, although the present invention manufactures the miniature projection type color display apparatus, the miniature projection type color display apparatus can have the same as or more outstanding efficiency. Also, the miniature projection type color display apparatus can be applied to small-sized color display apparatuses such as portable terminals, PDA and PMP.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A miniature color display apparatus, comprising:
N light sources, emitting each two-dimensional color beam of light, N is a natural number and is the same as or larger than 3;
a path adjusting material, adjusting an emission path of each color beam of light to allow each color beam of light emitted from the N light sources to be emitted though the same path;
an optical modulator, optically modulating each incident color beam of light according to light intensity information;
a beam converter, converting the two-dimensional color beam of light to a one-dimensional color beam of light to allow each color beam of light having the emission path adjusted by the path adjusting material to be one-dimensionally incident on the optical modulator; and
a scanner, receiving the modulated beam of light generated by the optical modulator and two-dimensionally projecting the received modulated beam of light on a screen.

2. The apparatus of claim 1, wherein the light source is one of a luminescent diode (LED), a laser diode (LD) and an organic light emitting diode (OLED).

3. The apparatus of claim 1, further comprising a collimation lens, adjusting an emission angle of the color beam of light emitted by the light source to allow the color beam of light emitted from the light source to be emitted in parallel.

4. The apparatus of claim 1, wherein the N light sources are 3 light sources of a first light source, a second light source and a third light source, which emit each different color beam of light, and the path adjusting material is arranged in front of each light source one by one per each light source.

5. The apparatus of claim 4, wherein the first light source, the second light source and the third light source are light sources of 3 primary colors of light, red, green and blue.

6. The apparatus of claim 4, wherein the path adjusting material is a totally reflective prism having a plurality of reflective surfaces.

7. The apparatus of claim 6, wherein any one of the path adjusting materials arranged one by one per each light source further comprises
a first lens, coupled to an incident surface of the totally reflective prism and enlarging a diameter of the two-dimensional color beam of light emitted from the light source; and
a second lens, coupled to an emission surface of the totally reflective prism and allowing the two-dimensional color beam of light emitted through the totally reflective prism to be incident on the beam converter in parallel.

8. The apparatus of claim 1, wherein the beam converter comprises
a one-dimensional beam formation lens, maintaining a length of a first axis direction of the two-dimensional color beam of light as it is and allowing a length of a second axis direction which is orthogonal to the first axis direction to be concentrated on a focusing point of the optical modulator.

9. The apparatus of claim 8, wherein the one-dimensional beam formation lens is a cylinder lens in which curvature is placed on any one directional surface,
whereas the one directional surface on which the curvature is placed is a surface corresponding to the same direction as the second axis direction of the two-dimensional color beam of light.

10. The apparatus of claim 9, wherein the one directional surface of the cylinder lens is an aspheric profile.

11. The apparatus of claim 1, wherein the optical modulator comprises a substrate;
an insulation layer, placed on the substrate;
a lower optical reflection layer, placed on the insulation layer and reflecting or diffracting an incident beam of light;
a structure layer, having a center part which is placed away from the insulation layer at a predetermined interval;
an upper optical reflective layer, placed on the center part of the structure layer and reflecting or diffracting the incident beam of light; and
a piezoelectric driving element, placed on the structure layer and allowing the center part of the structure layer to move up and down.

12. The apparatus of claim 1, further comprising an image control circuit, generating the light intensity information and transferring the generated light intensity information to the optical modulator.

13. The apparatus of claim 1, further comprising a projection lens enlarging a projection range of the modulated beam of light that is two-dimensionally projected on the screen.

14. The apparatus of claim 1, wherein the scanner is a polygon mirror scanner or a galvanometer scanner.
